(19) United States
(12) Patent Application Publication
(10) Pub. No.: US 2007/0089737 A1
(43) Pub. Date: Apr. 26, 2007

(54) Internal deflector for respiratory mask

(76) Inventor: Christopher S. Martin, Springfield, OR (US)

Correspondence Address: CHRISTOPHER S. MARTIN, 445 S. 46TH, SPRINGFIELD, OR, 97478, US

(21) Appl. No.: 11/338,943

(22) Filed: Jan. 24, 2006

Related U.S. Application Data
(60) Provisional application No. 60/725,429, filed on Oct. 11, 2005.

(51) Int. Cl. A62B 18/00

(52) U.S. Cl. 128/200.27

(57) ABSTRACT

The “Internal Deflector for Respiratory Mask” is a one piece plastic deflector held in place by two adjustable mounting screws. It is designed to fit inside of a respiratory mask (cpap). The deflector prevents a direct flow of air/gas into the mask user's airways without inhibiting or impeding the set flow or pressure of the device. The shape is consistent (FIG. 1A); the size varies slightly and is determined by the size of mask it is to be installed in, e.g. small, medium, large. The deflector has an adjustment screw (FIG. 2A) to allow for quick minor wearer adjustments. This deflector greatly reduces the irritation and discomfort of the interior of the mouth and nostrils associated with the use of respiratory masks.

This patent application claims priority to provisional patent application #60/725,429 filed on Oct. 11, 2005

### BACKGROUND OF THE INVENTION

In the art of the treatment of breathing disorders during sleep (sleep apnea), it is a common practice to implement the use of continuous positive air pressure (cpap) machines and related equipment. One such part of this equipment being used is a respiratory (cpap) mask. With this equipment outside air/gases are pumped into the respiratory mask at higher than atmospheric pressure to control sleep apnea. The respiratory masks, for this treatment, currently being manufactured are of such design that the flow of air/gas into them is directed into the mouth and nostrils of the wearer. This flow of air/gas into the airways causes irritation and discomfort to the wearer. This invention alleviates this condition.

### STATEMENT REGUARDING FEDERALLY SPONSORED RESEARCH

Not applicable.

### REFERENCE TO SEQUENCE LISTING, OR A DISC APPENDIX

Not applicable

### BRIEF SUMMARY OF INVENTION

This invention is a plastic deflector installed inside respiratory masks. The deflector is installed without modification to the mask. The deflector is held in place by up to two (2) mounting bolts and hardware. The deflector is designed to prevent the flow of air/gas from directly entering the mouth and nostrils of the mask wearer. The design of the deflector is such that upon installation there is no added adjustment of the air/gas volume or pressure required. Installation of the deflector greatly reduces the discomfort and irritation of the airways of the mask user.

### BRIEF DESCRIPTION OF THE SEVERAL VIEWS OF THE DRAWING

FIG. 1A. Front view of deflector showing Deflector Shape, location of mounting holes, the location of the adjustment screw hole. Without mounting hardware or adjustment screw.

FIG. 2A. Side view of the deflector shown with mounting hardware and adjustment screw in place.

FIG. 3A. Side view showing orientation of deflector to respiratory mask.

FIG. 4A. Front view showing orientation of deflector to respiratory mask.

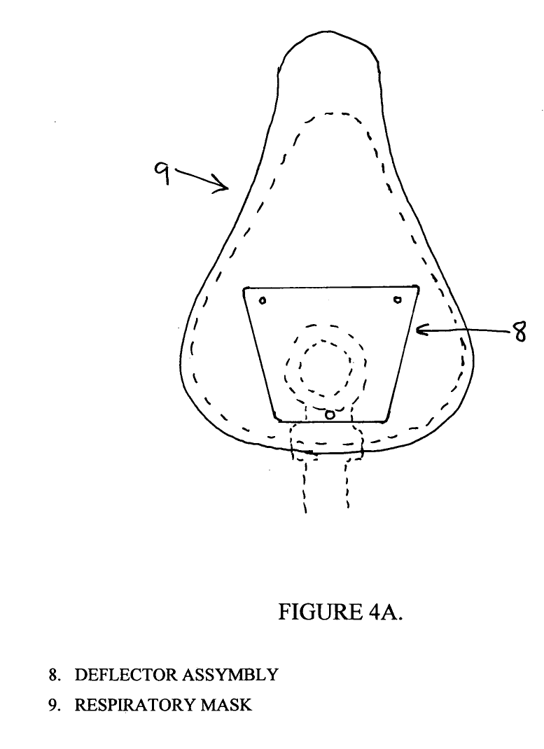

FIG. 5A. Overall view of deflector assembly.

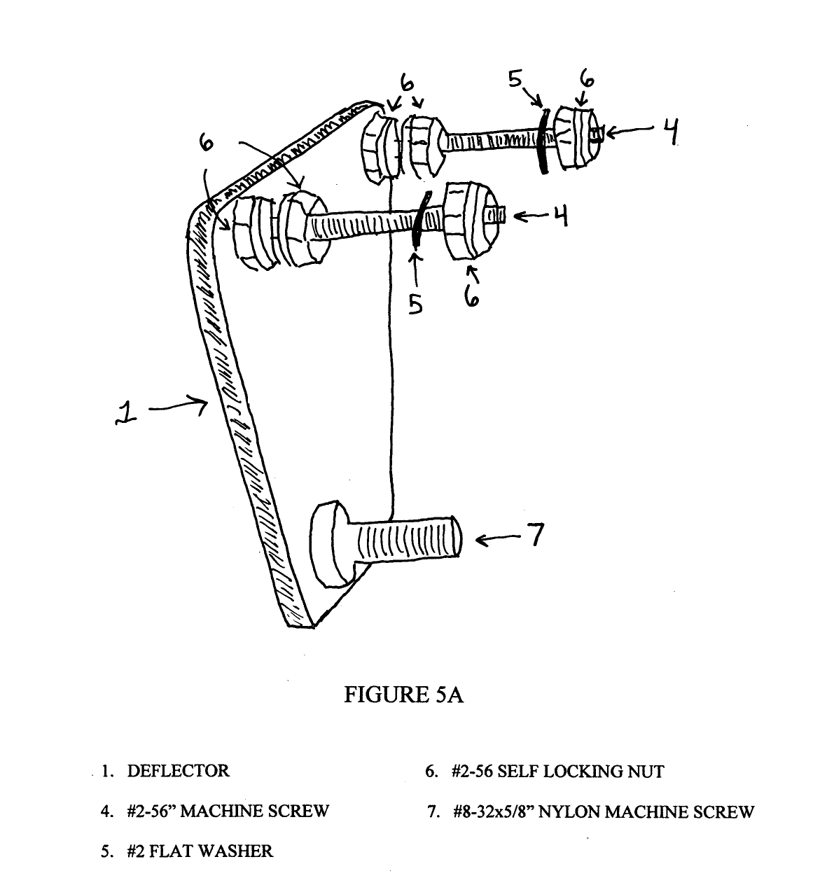

### DETAILED DESCRIPTION OF THE INVENTION

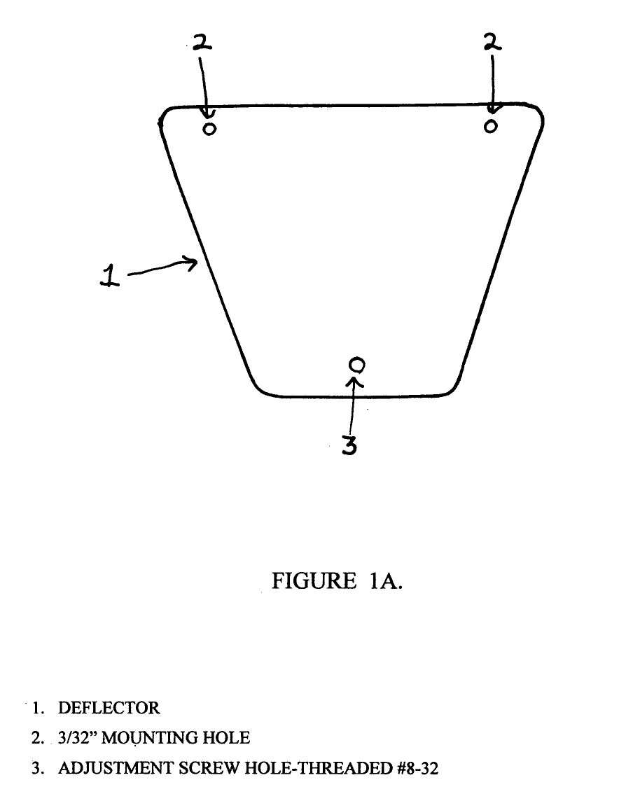

The deflector is of specific shape (FIG. 1A) and constructed of high impact shatter resistant plastic approximately 3/32″ thick. There is one 3/32″ mounting hole located in each of the upper corners (FIG. 1A). There is one ⅛″ hole centered in the bottom of the deflector (FIG. 1A) threaded for a #8-32 machine screw, this screw allows for minor wearer adjustments. The shape is consistent; the size varies slightly depending on the size of mask being installed in, e.g. small, medium, and large.

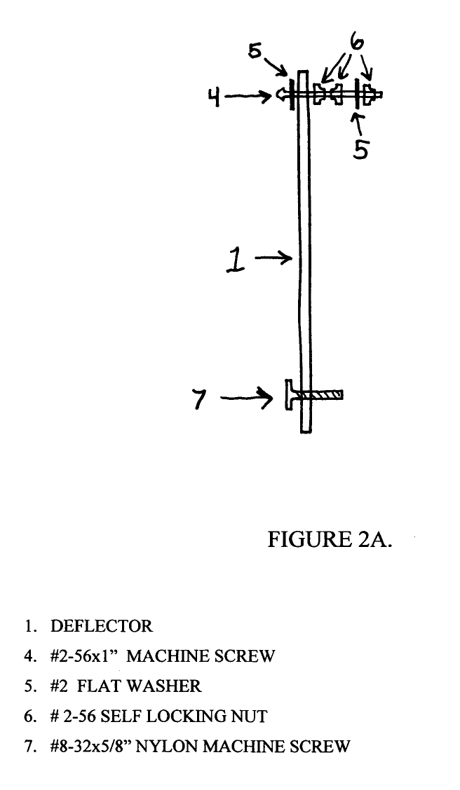

The mounting hardware consists of two (2) size #2-56×1″ bolts, six(6) size #2-56 self locking nuts, four (4) size #2 flat washers all of which are quality stainless steel. The adjustment screw is of the size #8-32×⅝″ and is constructed of nylon material. The mounting bolts are secured to the deflector using one (1) size #2 flat washer and one (1) size #2-56 nylon locking nut (FIG. 2A). The adjustment screw is threaded thru the deflector (FIG. 2A).

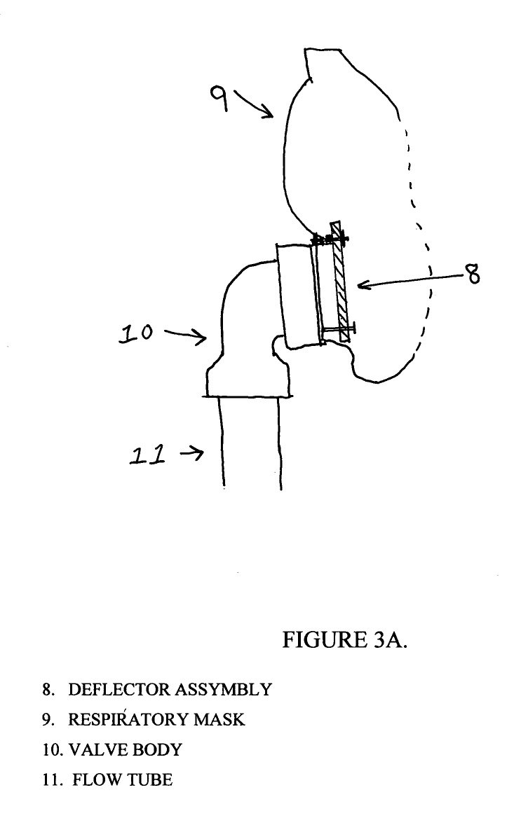

The deflector is secured inside the respiratory (cpap) mask by inserting the mounting bolts thru the mask auxiliary gas ports located on either side of the valve frame (FIG. 3A) and securing with one size #2-56 nylon locking nut on each side of the mask and one(1) size #2 flat washer between the mask port and nut on the outside of the mask(FIG. 2A).

The deflector has the option of using only one mounting bolt to allow for the use of an auxiliary port for the introduction of additional oxygen and or gases. This is accomplished by removing one (1) set of the mounting hardware bolt and nut.

What is claimed is;

1. A deflection device of specific shape (FIG. 1A) and mounting hardware (FIG. 2A) for installation inside of a respiratory mask (FIG. 3A) to ease, reduce or eliminate the flow of air/gas directly into the respiratory mask user's mouth and nostrils.

2. A deflector, as in claim 1, wherein the mounting of said deflector may be accomplished using one or both of the mounting bolts.

3. A deflector, as in claim 1, wherein the deflector is designed with an adjustment screw (FIG. 2A) allowing for minor wearer adjustments.

4. A deflector, as in claim 1, wherein installation and removal does not require modification of the respiratory mask.

5. A deflector, as in claim 1, does not inhibit nor impede the flow of air/gas and does not require adjustment to the air/gas volume or pressure, before, during, or after installation.

6. A deflector, as in claim 1, has the option of being mounted by one bolt only, to allow for the use of one of the auxiliary ports for the introduction of additional oxygen/gases into the mask.

7. A deflector, as in claim 1, is easily, simply and quickly installed and removed by the mask user without specialized training.

8. A deflector, as in claim 1, wherein the mounting of such deflector is accomplished thru the use of the respiratory mask auxiliary ports only.
